(19) United States
(12) Patent Application Publication
(10) Pub. No.: US 2005/0171924 A1
(43) Pub. Date: Aug. 4, 2005

(54) System for recommending program information in accordance with user preferences

(76) Inventors: Maurice Joseph McGinley, East Fremantle (NL); Wilhelmus Franciscus Johannes Verhaegh, Eindhoven (NL); Petrus Gerardus Meuleman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,283

(22) PCT Filed: Feb. 5, 2003
(86) PCT No.: PCT/IB03/00414

(30) Foreign Application Priority Data
Mar. 6, 2002 (EP) 02075901.5

(51) Int. Cl. G06F 7/00

(52) U.S. Cl. 707/1

(57) ABSTRACT

A system for recommending program information in accordance with user preferences, the system comprising receiving means (110) for receiving the program information and program schedule data pertaining to time schedules for receiving program information, input means (120) for providing a user input to the system, recommending means (160) for analyzing the user preferences and rating the program schedule data in accordance with said user preferences, and establishing preferred program schedule data (210) based on said rating, and presentation means (150) for presenting said preferred program schedule data (210) to a user. The system comprises means for accommodating at least one further recommending means (170) for establishing further preferred program schedule data from the program schedule data in accordance with the user preferences, the presentation means (150) being arranged to present information representative of said further preferred program schedule data (220) for evaluation of a quality of the further recommending means.

The invention relates to a system for recommending program information in accordance with user preferences, the system comprising receiving means for receiving the program information and program schedule data pertaining to time schedules for receiving program information, input means for providing a user input to the system, recommending means for analyzing the user preferences and rating the program schedule data in accordance with said user preferences, and establishing preferred program schedule data based on said rating, and presentation means for presenting said preferred program schedule data to a user.

The invention also relates to a method of recommending program information in accordance with user preferences, the method comprising a step of receiving the program information and program schedule data pertaining to time schedules for receiving program information, a step of providing a user input to the system, a step of analyzing the user preferences and rating the program schedule data in accordance with said user preferences, and establishing preferred program schedule data based on said rating, and a step of presenting said preferred program schedule data to a user.

An embodiment of such a system is known from document GB 2,354,902.

The document discloses an automatic method for the management of a display of information to be viewed on a screen of a television set. The television set receives information messages, content such as television programs or the like, and a comprehensive menu message pertaining to time schedules for broadcasting the information message. As selections of any piece of information are made for viewing on the television screen the relevant piece of information is identified and interpreted as a sociocultural criterion, and a list of weighted criteria is created to determine a user's profile. A filtering list is produced by using the list of the weighted criteria. The filtering list is designed to prepare a preferred menu from the comprehensive menu in choosing only time schedules for broadcasting the information messages, one type of which corresponds to the user's sociocultural profile.

A further filtering list can be created on the basis of the former filtering list. One difference between these lists lies in one of the fields and fields that are related to different descriptions of contents of the same respective programs. Examples of such fields are a field indicating a channel number of the program, a field indicating information about a type, category of the program, etc.

Thus, the recommended content is included in the preferred menu and displayed on the screen to the user. The preferred menu is reduced because it only shows information preferred by the user, in accordance with his/her habits. The user is left a possibility of choosing an arrangement of said menu to be displayed. For the default arrangement, a combination between the type of program and a time slot is used. The user can be provided with additional information that shows him/her programs which are not recommended.

In this way, systems known in the prior art provide the recommended content to the user, such as the TV programs, targeted advertising or other types of information, in accordance with the user's preferences, habits etc. Of course, the user is recommended only a small part of the received content and said part is extracted in accordance with the user preferences. The recommendations can be made on the basis of data about a user's preferred period of time for watching the programs, or a structure of data such as the filtering lists known from document GB 2,354,902, information about the favorite programs stored in user profile data, etc. Such data are used for sorting out the schedule information for receiving the content, etc.

Many ways of presenting the recommended content are known in the prior art. For example, the recommended and not recommended content can be presented to the user simultaneously in one list, grid or in the separately arranged presentations, while the system may allow the user to browse and modify the user profile data, etc. However, given such presentations, it is not easy for the user to determine how well or badly the system recommends the content.

A quality of recommending the content by the system may change with time. This may happen due to different reasons such as: changes of a quality or amount of the user preference data, user profile data, etc; evolving user preferences, etc. An ability of any recommender system to successfully match content to the end user's preferences is likely to become worse with time. The user provided with the recommender systems known in the prior art cannot judge and does not know with confidence if a performance of a poorly functioning system is improved or deteriorated. It is especially difficult for the user to assess the performances of two different recommending systems available at the same time.

It is an object of the invention to provide a system for recommending program information of the kind defined in the opening paragraph, wherein the user is informed about a quality and changes of quality of the recommending system, the user being able to determine and select one of the recommending systems on the basis of their performances.

This object is realized in that the system comprises means for accommodating at least one further recommending means for establishing further preferred program schedule data from the program schedule data in accordance with the user preferences, the presentation means being arranged to present information representative of said further preferred program schedule data for evaluation of a quality of the further recommending means.

In this way, the preferred program schedule data and further preferred program schedule data are representative of different sets of the programs recommended to the user for watching, recording, etc. in accordance with the user's preferences. The information representative of said further preferred program schedule data may be any information composed from said further preferred data to enable the user to evaluate the quality of the further recommending means. Said information may be in particular a part of the further preferred program schedule data.

There are many ways of preparing the information representative of the further preferred program schedule data. Ultimately, the prepared information is presented in such manner that the user is informed adequately enough to give the recommendations of the further recommending means a proper evaluation.

For example, said information may be provided in the form of a report about the recommended programs. First, the programs recommended by the further recommending means may be sorted by predetermined categories, types of programs, etc. Furthermore, the number of the programs recommended in each category and respective rating of these programs are indicated. Thus, the user is provided with a brief overview of the programs recommended by the further recommending means.

The preferred program schedule data and information representative of further preferred program schedule data are presented to the user in such a way that the user can compare the program schedule data recommended by different recommending means.

According to the present invention, the system comprises the means for accommodating the further recommending means from third parties, or the system comprising the recommending means and further recommending means is provided by the manufacturer, so that said means need not be acquired.

The difference between recommending means and further recommending means is that they may include different means for analyzing the user preferences, and/or rating the program schedule data and/or establishing the preferred program schedule data. For example, said means may be distinct software from different manufactures, or the same software utilizing different criteria for rating the program schedule data, or the like. As a result, one of said means may recommend the programs better or worse than the other one.

In an embodiment of the present invention, the user is also provided with the rating of the program schedule data accomplished by the further recommending means. For example, the data rated on the basis of the user's preference analysis and the recommended programs are presented to the user on the same screen. Being presented with the preferred program schedule data, information representative of the further preferred program schedule data and rating of the program schedule data simultaneously, the user can determine the quality of recommending on the basis of this accomplished and presented rating. The user can also assess a correctness of said rating with respect to his/her preferences, for example how the user profile stored in the system matches with the user's actual interests.

In a further embodiment, only a relatively small percentage, or part, of the further preferred program schedule data, and/or preferred program schedule data, is presented to the user. Indeed, it is not convenient for the user when the number of recommended programs is large, and it takes quite some time to browse the recommendations. Thus, only a percentage of the further preferred program schedule data is supplied to the user.

Said percentage can be varied by the user, predetermined in the system, etc. For example, it is known in the prior art that a threshold can be used for establishing the preferred program schedule data on the basis of the rating performed by the recommending means. Said threshold can be applied to the further preferred program schedule data to select the percentage of said data, and modified for varying said percentage.

The percentage of the further preferred program schedule data presented to the user can be selected with respect to a relevance to the user preferences, on the basis of the accomplished rating of the schedule data.

In another implementation, said percentage is selected in a random way. For example, if the user would like to be provided with the limited number of recommended programs in accordance with the types of the recommended programs, and the further preferred program schedule data comprise more programs of the particular type than is required, the required number of programs can be obtained by the random selection from the programs of this particular type.

The system may comprise choosing means to inform the system which recommending means has been selected to be further used for recommending the content. The choosing means may also be used to enable the user to indicate which parts of the content recommended by the recommending means and/or further recommending means he/she likes or does not like.

The object of the present invention is also realized in that the method comprises a step of establishing further preferred program schedule data from the program schedule data in accordance with the user preferences, a step of presenting information representative of said further preferred program schedule data for evaluation of a quality of recommending said further preferred program schedule data. The method comprises the steps of operation of the system of the present invention.

These and other aspects of the present invention will be further elucidated and described with reference to the accompanying drawings, wherein:

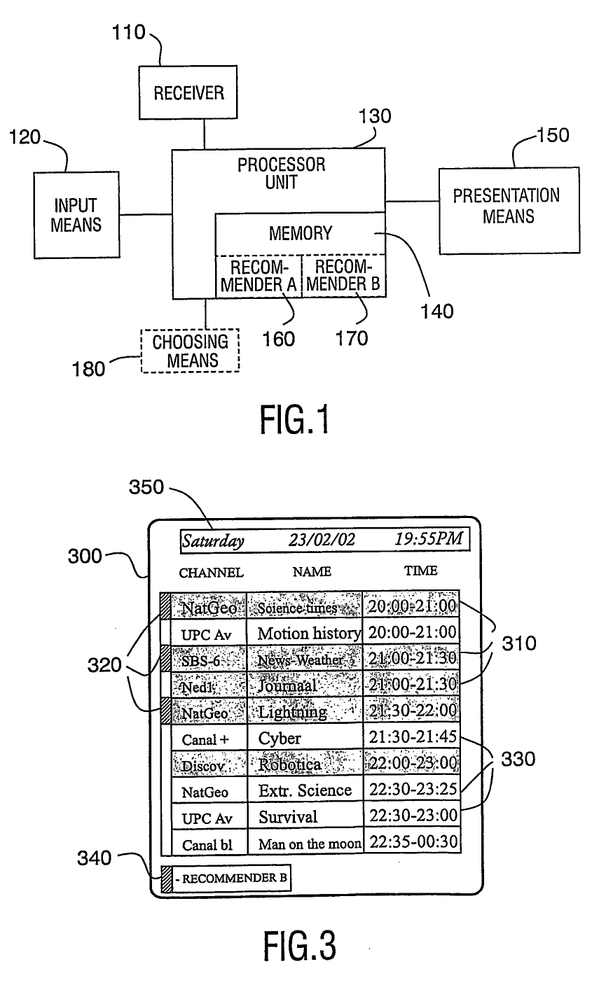

FIG. 1 shows a functional block diagram of the system of the present invention;

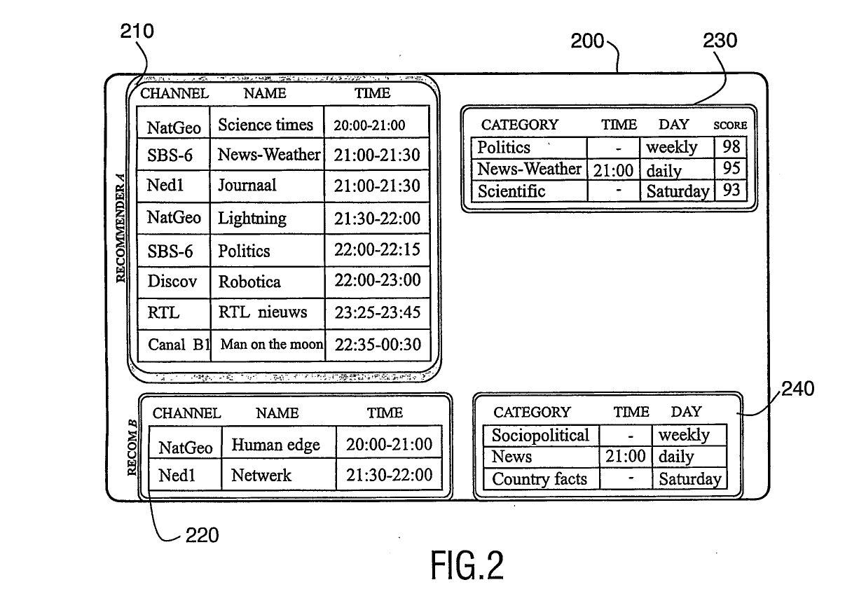

FIG. 2 shows an embodiment of the present invention, wherein the preferred program schedule data, information representative of the further preferred program schedule data and the user's preference data are shown;

FIG. 3 shows an embodiment of the present invention, wherein the preferred program schedule data, information representative of the further preferred program schedule data and non-preferred program schedule data evaluated as being of less or no user's interest are presented in the same table;

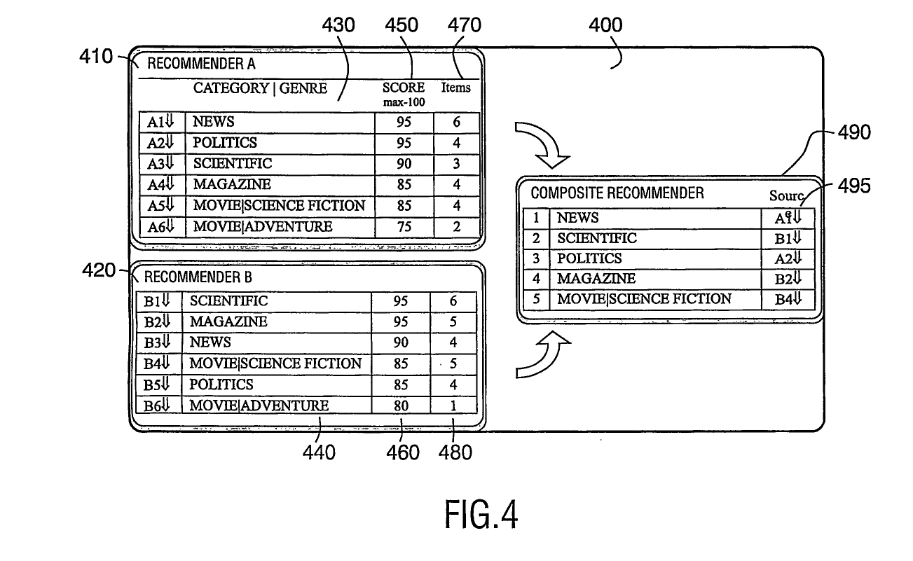

FIG. 4 shows an embodiment of the present invention, wherein a composite recommendation list is formed from the preferred program schedule data and further preferred program schedule data;

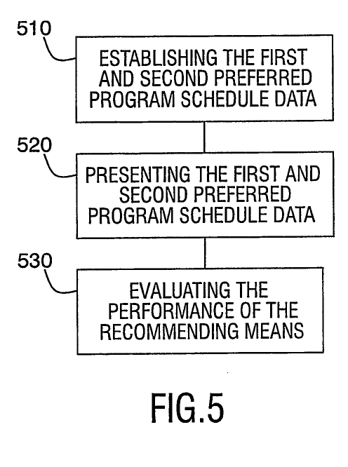

FIG. 5 shows a flow chart of the method of the present invention.

Referring to the drawings, FIG. 1 shows a functional block diagram of the system of the present invention. The system comprises receiving means 110 for receiving the program information and program schedule data pertaining to time schedules for receiving program information, input means 120 for providing a user input to the system, a processor unit 130 controlling the operation of the system in accordance with instructions, the received program information and program schedule data stored in a memory 140, and presentation means 150. The recommending means 160 and further recommending means 170 can be implemented in the form of the instructions to be executed by the processor unit 130, which are stored in the memory 140. The program information and program schedule data can be supplied to the system by means such as electrical conductors, fiber optic cables, satellite delivery, microwave delivery or mobile telephone network delivery, data carriers, or in any other manner. The receiving means can be accordingly arranged to receive the information in any mentioned way. The programs may be broadcast television programs, targeted advertising supplied by means of the Internet, etc. The program information and program schedule data may be composed in any currently known format. Using the input means, the user can at least select different programs. To make these selections, the user may use a keyboard, mouse, remote control unit or other user input device.

The recommending means 160 and further recommending means 170 analyze user preferences, rate the program schedule data in accordance with the user preferences and establish preferred program schedule data and further preferred program schedule data, respectively, from the rated program schedule data based on said rating. The processor unit 130 is arranged to independently perform operations of the recommending means and further recommending means. The processor unit 130 comprises a microprocessor (or microcontroller, or microcomputer), input/output circuitry, as well as other circuitry and components that are well known to those skilled in the art. The processor unit 130 has also a function of controlling the flow of information between different elements of the system. However, many other variations of implementing the recommending means and further recommending means are possible. The scope of the invention is not limited to the particular implementations described in this document. It is to be understood that more than two recommending means can be implemented with the processor unit 130.

As the user watches, listens, browses TV channels, advertising information, etc., the processor unit 130 using the input information received via the input means analyzes a user's behavior and preferences, and collects data about these user's preferences, habits. The user may also indicate his/her preferences explicitly. In this way, the system establishes, stores and modifies user profile data, filter data of program preference, or the like, as is known in the prior art. If the recommending means 160 and further recommending means 170 include different means for analyzing the user behavior, this may result in maintaining different data related with the user's preferences, habits. For example, different user profile data may be rendered by the recommending and further recommending means and stored in the memory 140.

The program schedule data are rated in accordance with the user preferences. The processor unit 130 communicates with the memory 140 to access the program schedule data and data related with the user preferences, and to determine the program schedule data matching the user preferences. A subset of the program schedule data is selected from all program schedule data stored in the memory. In this way, the preferred program schedule data are established.

The recommending means 160 and further recommending means 170 may comprise different means for evaluating a correlation between the program schedule data and user preferences. As a result, the further preferred program schedule data that are different from the preferred program schedule data are established by the further recommending means.

The recommending means and further recommending means can be implemented with separate programs to be executed by the processor unit. Said means can also be implemented by the same computer program which has different configurations causing different operations of this program when said different configurations are used.

The further recommending means 170 may be implemented with the computer program product to be executed by the processor unit 130. The processor unit 130 may instruct the receiving means 110 to receive the program instructions from an external source, such as the Internet, and to accommodate them in the memory 140. In this way, a plurality of the further recommending means can be provided to the system. The different configurations causing different operations of the same program product, the recommending means, can also be obtained in the described manner.

This will be especially convenient when companies providing parts of the system regarding the recommending means expose their end products in the form of software available on the Internet. In that case, the software of the further recommending means, which may function better or will function better then the recommending means, can be easily acquired by the system.

The presentation means 150 are arranged to present information representative of the further preferred program schedule data, which information is further referred to as “representative information” solely for the purpose of text conciseness. The representative information is constituted from the further preferred program schedule data and then presented to the user. The representative information may be composed in such a way that it will be easier for the user to evaluate how the further preferred program schedule data match with his/her actual interests on the basis of said information, rather than being presented with the further preferred program schedule data themselves. In other words, the representative information may be easier than the further preferred program schedule data to perceive. The representative information may also be just a part of the further preferred program schedule data, which may comprise data which are selected from the further preferred program schedule data as the most likely of user's interest. The system may enable the user to navigate the representative information for viewing or the like.

Being provided with the representative information, the user has a possibility of evaluating a quality of the further preferred program schedule data recommended by the further recommending means. The system may comprise choosing means 180 enabling the user to select the recommending means or at least one of the further recommending means, for further recommendation of the content. The choosing means may be implemented by means of one or more buttons on the remote control unit, keyboard, etc., a user-selectable menu, or other user interface means which may form a part of the input means. The processor unit 140 may also be arranged to select the recommending means or further recommending means for further recommending the content without participation of the user, and function as the choosing means to accomplish said selection.

The representative information and preferred program schedule data may be presented to the user simultaneously, for example on the screen. Thus, the user has a possibility of comparing the content recommended by different recommending means.

The present invention can be applied to any device comprising means for communicating the program schedule data to the user, such as a display screen in a television set, computer or any other device capable of selecting and recommending user-perceivable information such as the television programs.

In one of the embodiments of the present invention, the system is arranged to provide the user with the representative information using means other than the presentation means. For example, handicapped persons may use special tangible devices that dynamically provide the text information, which may be the further preferred program schedule data, to the user.

The system is not required to have the particular configuration shown in FIG. 1, but rather may include any other components known by the persons skilled in the art. All details shown in FIG. 1 may be replaced with other technically equivalent elements.

FIG. 2 shows an embodiment of the present invention, wherein the preferred program schedule data, information representative of the further preferred program schedule data and the user's preference data are shown.

Possible implementations of the present invention are now described with reference to an Electronic Programming Guide (EPG) field. FIG. 2 shows a display screen 200 in which the preferred program schedule data 210 recommended by the recommending means, and information representative of the further preferred program schedule data 220 recommended by the further recommending means are presented. The data 210 and information 220 are presented in a table with columns indicating a channel associated with the particular recommended program; title, brief description, etc. of the program; time of broadcasting the recommended program. Additionally, the rating of the recommended programs according to the recommending means or further recommending means may also be shown in frame 210 and/or frame 220. Other formats such as lists, two-dimensional grids of presenting also other types of the recommended content such as information available on the World Wide Web pages are possible as well.

In this particular embodiment, the information representative of the further preferred program schedule data 220 is a relatively small percentage, or a part, of said data which may be extracted in a plurality of ways for the user's awareness and convenience.

For example, said part may be selected from the further preferred program schedule data in conformity with a relevance to the user preferences. This selection may be made on the basis of the rating of the further preferred program schedule data. For example, only programs with the highest rating are selected. The programs of the further preferred program schedule data may also be sorted according to their types, topic, etc., and the selection of the programs with the highest rating may be done separately among the programs having a similar topic, etc.

The further preferred program schedule data usually consist of both recommendations with a high and a low rating at the same time. To provide the user with an overview of the programs recommended by the further recommending means, with different ratings, the system may select said percentage of the further preferred program schedule data in a random way. For example, all further preferred program schedule data may be sorted in accordance with the rating of the respective program. The programs with a similar rating may be identified from all data so that at the end all data are sorted for specified sets. A selection of one or more programs may be done in the random way in each set, or only in the sets containing the large number of programs, or in some sets depending on the type of the respective program, and so on.

It should be noted that in the system a priority may be given to provide the user with a large percentage of the preferred program schedule data, while only part of the further preferred program schedule data is presented at the same time. This will be found especially useful when the further recommending means recommend the content as being not good enough at the moment but the user or system expects that the quality of the further recommending means may improve in future.

The user's preference data 230 created and maintained by the recommending means to establish the preferred program schedule data 210 are shown on a screen 200. The user's preference data 240 created and maintained by the further recommending means to establish the information representative of the further preferred program schedule data 220 are also shown on screen 200. Being presented with such a screen, the user can easily identify the recommending means analyzing user's preferences better or worse when the user's preference data utilized by said means are shown. The user also has a possibility to assess a quality of recommendations on the basis of the shown user's profile data. The user's preference data shown in frames 230 and 240 are only examples of the data indicating the user preferences, habits or the like. Other types and variations of said data are possible.

The number of frames with the tables indicating the recommended content and/or user's preference data rendered by the recommending means may be equal to the number of different recommending means functioning in the system.

FIG. 3 shows a display screen 300 wherein the preferred program schedule data 310, information representative of the further preferred program schedule data 320 and non-preferred program schedule data 330 evaluated by the recommending means and/or further recommending means as being of less or no user's interest are presented to the user in the same table.

The presentation means may be arranged to sort the data presented in frame 300 according to the rating of the data, e.g. the higher rating of the program means that this program is closer to the top of the table, or vice versa. In this way, there may be no need to show the rating of the programs because the user will know that the position of the particular program in the table corresponds to the rating of the respective program. Additionally, the programs in frame 300 may be sorted according to the time and/or day of receiving or broadcasting the particular program. At the same time, the programs may also be sorted with respect to the rating and time of receiving the programs.

The program schedule data in frame 300 are arranged in the table containing the same columns as the table that is shown in frames 210 and 220. The preferred program schedule data 310 recommended by the recommending means are highlighted by means of the color which is different from the rest of the data in the table.

The further recommending means may recommend some programs which are already presented in the table. In that case, such programs may be highlighted because they are recommended by the recommending means, and also additional marking such as hatching 320 or the like may be shown to inform the user that the particular program is also recommended by the further recommending means. Line 340 informs the user that the hatching indicates the further preferred program schedule data.

A date, day or week corresponding to the content indicated in frame 300 and current time counted in the system may be shown on line 350.

Other manners of indicating the preferred program schedule data and further preferred program schedule data are possible, while many variations of frame 300 may be derived. In one of the variations, non-preferred program schedule data 330 may not be shown, which may be more convenient for the user when many recommendations are made.

The rating of the respective program recommended by one of the recommending means may be additionally shown in frame 300 to inform the user how the recommending means and/or further recommending means evaluate the relevance of the particular program to his/her interests. The rating may indicated in percents wherein a high percentage means that the recommending means appraise that program as being highly correlated with the user preferences. The indication may also be done by means of points, different colors, diagrams, etc.

Frame 400 is shown in FIG. 4 wherein a composite recommendation list is formed from the preferred program schedule data and further preferred program schedule data.

It may appear that recommending means and further recommending means do not recommend content properly, and that the user is not satisfied with the quality of both means. However, the user knows that some types of programs are recommended acceptably by the recommending means. The further recommending means may well recommend another type of program. In such a situation, the choosing means 180 may be designed to enable the user to specify which types of programs recommended by the recommending means and/or further recommending means are to be recommended by the respective means, and further presented to the user. Both means may continue to function in the system without any preference to one of them. The user may be enabled to modify, upon request, his/her selections of said preferred types.

The preferred program schedule data and further preferred program schedule data may be sorted according to the same or different predetermined criteria such as genre, topic, theme, etc. The contents recommended by the recommending means and further recommending means may be shown separately in tables 410 and 420. The criteria applied to the preferred program schedule data and further preferred program schedule data are indicated in columns 430 and 440. The number of programs matching the same criteria and an estimated average score of these programs may also be indicated in columns 450 and 460, 470 and 480 of the tables 410 and 420, respectively.

If the user would like to see the preferred program schedule data or further preferred program schedule data selected according to one set of the programs matching the same criteria, said data may be shown in the same arrangement which is respectively and dynamically adjusted. This may be done in a variety of different ways. For example, first the user specifies an entry in the table 410 or 420 comprising the information about the program schedule data recommended by one of the recommending means and sorted according to one of the criteria to be shown in detail. The arrangement of the corresponding entry indicating said criteria is modified appropriately to position a list of programs, one example of which is shown in FIG. 3, which entry may be split, extended or the like.

Thus, only one or more specified entries in the table 410 or 420 are widened upon the user's request to inform the user sufficiently to identify some of the preferred program schedule data and further preferred program schedule data which better match the user's preferences. Once such data are identified, the user may select the respective entry in the tables 410 and 420. Said entries may be further visually indicated separately in frame 490 wherein an indication of the latter position of the entry in the table 410 or 420 is provided in column 495.

The preferred program schedule data and further preferred program schedule data of the types selected to frame 490 from frames 410 and 420 may be further recommended to the user in the arrangement shown in FIG. 2 or the like. The information shown in frames 410 and 420 is reduced because it may not comprise all the preferred program schedule data and further preferred program schedule data. However, other modifications of the described presentation are possible.

The number of tables comprising the preferred program schedule data and further preferred program schedule data may be uncrossed and equal to the number of different recommending means functioning in the system.

Different examples of presenting the recommended content are described in the preceding sections with reference to FIGS. 2, 3 and 4. However, these should not be assumed to be the only possible implementations.

In a further embodiment, the system comprises measurement means (not shown) for measuring the performance of the recommending means and then qualifying it. There are many ways of evaluating the performance of the recommending means. One such method is disclosed in document WO 01/60063. It can also be done, for example, first by estimating a correlation between currently recommended content, which has already been filtered from the received content, and data stored in the system and related to all explicit user's selections of the preferred content. Next, a ratio between a portion of highly correlated recommended content, determined by the measurement means from the content recommended by the particular recommending means, and the total amount of the content recommended by the particular recommending means is estimated. A respective gradation of the ratio may be further made in accordance with a predetermined scale which the user perceives easily.

Qualification of the recommending means can be done upon request of the user or the system, or automatically when a predetermined condition is satisfied, for example a periodical qualification may be done automatically at least once a month or at some other time. Results of the measurement can be provided to the user, who is further offered a possibility to specify which recommending means are to be selected for further recommending. The results can also be processed by the system, in which case the system selects the recommending means automatically and the user is not involved.

In a further embodiment of the present invention, the system may be adapted in such a way that explicit and/or implicit user preferences may be analyzed separately for establishing the preferred program schedule data or the further preferred program schedule data. For example, one of the recommending means and the further recommending means may be arranged to analyze only explicit preferences or only implicit preferences, whereas the other means may be arranged to analyze both explicit and implicit user preferences.

In one of the examples, the recommending means may be arranged to establish the preferred program schedule data on the basis of analyzing only the explicit preferences, and the further recommending means may be the recommending means arranged to analyze only the implicit preferences. In this case, the further preferred program schedule data are the preferred program schedule data established on the basis of analyzing the implicit preferences.

Alternatively, the further recommending means may be arranged to establish the further preferred program schedule data on the basis of analyzing only the explicit preferences, and the recommending means may be the further recommending means arranged to analyze only the implicit preferences. In this case, the preferred program schedule data are the further preferred program schedule data established on the basis of analyzing the implicit preferences. Other variations are possible.

In the embodiment described above, after the recommendations of the recommending means and further recommending means are presented to the user, the user or the system itself may evaluate a performance of the recommending means or further recommending means, when only implicit preferences or only explicit preferences are analyzed by said means. The proposed manner of using only explicit preferences or only implicit user preferences may help the user or the system to improve the recommendation process in the system. Additionally, the user may be surprised about the presented recommendations, for example, if the recommendations revealed some user preferences which he did not realize

The method of the present invention describes the operation of the system. The method comprises a step of receiving the program information and program schedule data pertaining to time schedules for receiving program information and a step of providing a user input to the system. The next step of the method contemplates analyzing the user preferences, rating the program schedule data in accordance with said user preferences, and establishing preferred program schedule data based on said rating. Said preferred program schedule data are presented to a user in the next step.

According to the present invention, the method comprises a step of establishing further preferred program schedule data from the program schedule data in accordance with the user preferences, said further preferred program schedule data being different from said preferred program schedule data, and a step of presenting at least a part of said further preferred program schedule data so that the user has a possibility of assessing a concord of said further preferred program schedule data with the user preferences.

In FIG. 5, a flow chart of an embodiment of the method is shown. In a further embodiment, in step 510, a first and a second preferred program schedule data are established from the rated program schedule data. It should be understood that the scope of the present invention is not limited by a variety of possible techniques of establishing the set of recommended programs.

In step 520, the first and second preferred program schedule data are presented on-screen to the user, or in the acoustical way by means of speakers, or in other ways. Finally, in the next step 530, the performance of the recommending means producing the first and second preferred program data is evaluated by the user, or automatically by the system as disclosed above in this document.

The various program products may implement the functions of the system and method of the present invention and may be combined in several ways with the hardware, or located in different devices. Variations and modifications of the described embodiment are possible within the scope of the inventive concept.

1. A system for recommending program information in accordance with user preferences, the system comprising receiving means (110) for receiving the program information and program schedule data pertaining to time schedules for receiving program information, input means (120) for providing a user input to the system, recommending means (160) for analyzing the user preferences and rating the program schedule data in accordance with said user preferences, and establishing preferred program schedule data (210) on the basis of said rating, and presentation means (150) for presenting said preferred program schedule data (210) to a user, characterized in that the system comprises
means for accommodating at least one further recommending means (170) for establishing further preferred program schedule data from the program schedule data in accordance with the user preferences,
the presentation means (150) being arranged to present information representative of said further preferred program schedule data (220) for evaluation of a quality of the further recommending means.

2. A system as claimed in claim 1, wherein the recommending means (160) and further recommending means (170) comprise different means for rating the program schedule data.

3. A system as claimed in claim 2, wherein the presentation means (150) are arranged to present to the user the rating of the program schedule data accomplished by said further recommending means.

4. A system as claimed in claim 1, wherein the further recommending means (170) are designed to select a percentage of the further preferred program schedule data to be presented by the presentation means.

5. A system as claimed in claim 4, wherein said percentage is selected by applying a threshold to the further preferred program schedule data, said threshold being based on the accomplished rating.

6. A system as claimed in claim 4, wherein said percentage of the further preferred program schedule data is user-adjustable.

7. A system as claimed in claim 4, wherein said percentage of the further preferred program schedule data is selected by the system from said further preferred program schedule data in a random way.

8. A system as claimed in claim 4, wherein said percentage of the further preferred program schedule data is selected by the system from said further preferred program schedule data with respect to a relevance to the user preferences.

9. A system as claimed in claim 1, further comprising choosing means (180) for providing the user with a choice of being further recommended with the program schedule data by the recommending means or further recommending means.

10. A system as claimed in claim 1, wherein the recommending means are arranged to analyze only explicit or implicit user preferences, or wherein the further recommending means are arranged to analyze only explicit or implicit user preferences.

11. A method of recommending program information in accordance with user preferences, the method comprising a step of receiving the program information and program schedule data pertaining to time schedules for the receiving of program information, a step of providing a user input to the system, a step of analyzing the user preferences and rating the program schedule data in accordance with said user preferences, and establishing preferred program schedule data on the basis of said rating and a step of presenting said preferred program schedule data to a user, characterized in that the method comprises
a step (510) of establishing further preferred program schedule data from the program schedule data in accordance with the user preferences,
a step (520) of presenting information representative of said further preferred program schedule data (220) for evaluation of a quality of recommending said further preferred program schedule data.

12. A computer program product enabling a programmable device, when executing said computer program product, to function as the system defined in claim 1.
